(19) United States
(12) Patent Application Publication
(10) Pub. No.: US 2018/0078884 A1
(43) Pub. Date: Mar. 22, 2018

(54) MODULE FOR CONNECTING FLOW TUBES, AND WATER PURIFIER HAVING SAME

(71) Applicant: COWAY CO., LTD., Chungcheongnam-do (KR)

(72) Inventors: Won-Il JOO, Seoul (KR); Sang-Hyeon KANG, Seoul (KR); Geun-Sang RYU, Seoul (KR); Ji-Hyeon HWANG, Seoul (KR)

(21) Appl. No.: 15/563,753

(22) PCT Filed: Mar. 29, 2016
(86) PCT No.: PCT/KR2016/003176

§ 371 Date: Oct. 2, 2017

(30) Foreign Application Priority Data
Mar. 31, 2015 (KR) 10-2015-0045161
Mar. 31, 2015 (KR) 10-2015-0045162

(51) Int. Cl. B01D 35/30; B01D 29/50

(52) U.S. Cl. CPC B01D 35/30; B01D 29/50

(57) ABSTRACT

A flow tube connection module and a water purifier including the same are provided. The flow tube connection module includes a housing having a coupling space in which a first flow tube and a second flow tube are connected to each other; a tube connecting member provided in the coupling space and connecting the first flow tube and the second flow tube to each other; an enlarged coupling portion provided in the housing; a coupling body coupled to the enlarged coupling portion to connect a plurality of the housings; and a separation prevention cover or a connection release member assisting the first flow tube in being connected to or separated from the tube connecting member.

### TECHNICAL FIELD

The present disclosure relates to a flow tube connection module, by which flow tubes, through which a fluid flows, are connected to or disconnected from each other, and a water purifier including the same.

### BACKGROUND ART

Water filters filter water to obtain purified water and supply the purified water to users. Such water filters are provided with filtering members disposed therein, to filter water.

Water filters are provided with inflow tubes, through which water flows in, and outflow tubes, through which water having passed through filtering members provided therein flows out. To this end, the filtering members are provided in receiving spaces formed inside the water filters configured to allow water to flow in and out. Water flowing into the water filters through inflow tubes is filtered while passing through the filtering members, and then flows out to the outside of the water filters through the outflow tubes.

General water purifiers have a plurality of such water filters. Water supplied to the water purifiers is sequentially passed through different filtering members provided in the plurality of water filters, and finally purified water is supplied to users.

Thus, a connection module, not only connecting an inflow tube and an outflow tube provided in each of a plurality of water filters, but also combining and fixing the water filters themselves, is required.

The water filter connection module is configured such that a water filter may be connected, water to be filtered flows into the connected water filter, and the water filtered by the water filter is discharged.

Thus, it may be very important to maintain a connection state in which the water filter is connected to the water filter connection module, without separating the water filter connected to the water filter connection module therefrom. In the case in which an inflow tube and an outflow tube of the water filter are separated from the water filter connection module, water may not be smoothly supplied, and a leakage phenomenon may occur.

A water filter connection module according to the related art is configured such that a water filter is attached to the water filter connection module, while being moved upwardly in a state in which the water filter is positioned below the water filter connection module. For example, the water filter may be attached to the water filter connection module in a screw coupling manner, or in a manner in which the water filter is caught by a stop protrusion formed on the water filter connection module.

However, such a method has a problem in that the size of a water purifier is increased together with an increase in the size of a water filter connection module itself, and material costs also rise as the number of components increases.

Furthermore, in the case in which the water filter connection module is located in a relatively low position, an operation of connecting a water filter may not be easy, and in the case in which there is not enough space for the water filter to be positioned below the water filter connection module, an operation of connecting the water filter may also not be facilitated.

In detail, in the case in which a water filter is connected to a water filter connection module in a manner in which an inflow tube and an outflow tube of the water filter are held by the water filter connection module, when high-pressure water flows into the water filter, a problem in which the water filter falls at the time of connecting the water filter may occur.

Further, there may be a problem in that water leakage may occur in a portion of the water filter connection module, to which the water filter is connected, due to a load of the water filter itself.

### DISCLOSURE

### Technical Problem

An aspect of the present disclosure is to provide a flow tube connection module configured to interconnect flow tubes, through which a fluid flows, for example, an inflow tube and an outflow tube provided in a plurality of water filters, to each other, and to easily couple the water filters to or separate the water filters from a water purifier, and a water purifier including the same.

In detail, coupling or separation operations of a water filter may be facilitated.

In addition, an inflow tube and an outflow tube of a water filter coupled to a body of a water purifier may be prevented from being released from a connection state thereof due to pressure of supplied water.

Further, a plurality of water filters may be connected to each other to improve filtration or purification of supplied water.

Furthermore, the number of required components may be significantly reduced, thereby decreasing manufacturing costs of products.

### Technical Solution

According to an aspect of the present disclosure, a flow tube connection module described below and a water purifier including the same are provided.

First, a flow tube connection module according to an aspect of the present disclosure includes a housing having a coupling space in which a first flow tube and a second flow tube are connected to each other; a tube connecting member provided in the coupling space and connecting the first flow tube and the second flow tube to each other; an enlarged coupling portion provided in the housing; a coupling body coupled to the enlarged coupling portion to connect a plurality of the housings; and a separation prevention cover or a connection release member assisting the first flow tube in being connected to or separated from the tube connecting member.

The first flow tube may be provided as an inflow tube and an outflow tube provided in a head portion of a water filter.

The tube connecting member may include a first flow channel connection port to which the first flow tube is connected, and a second flow channel connection port to which the second flow tube is connected.

The tube connecting member may include connection caps installed in the first flow channel connection port and the second flow channel connection port, to fix the first flow tube and the second flow tube, respectively.

The flow tube connection module may further include a close contact member inserted into at least one of the connection caps to be in close contact with the first flow tube or the second flow tube.

The connection cap may include an inclined portion configured to be inclined in a length direction of the first flow tube or the second flow tube, and the close contact member may be moved along the inclined portion when the first flow tube or the second flow tube moves, to be in close contact with the first flow tube or the second flow tube.

The close contact member may include a body portion inserted into the connection cap to be in close contact with the first flow tube or the second flow tube, and to be in contact with the inclined portion, and a head portion extended from the body portion outwardly of the connection cap, to be exposed externally of the connection cap.

The body portion may include a separation prevention projection protruding toward the inclined portion to move along the inclined portion, and a plurality of separation grooves formed in a circumferential direction thereof, and may be configured to be elastically transformed in a center direction when the connection cap presses the body portion in the center direction.

The head portion may include a stop protrusion protruding outwardly of the connection cap.

The separation prevention cover may be provided on the housing to move, and may be configured to extend in an outer circumferential direction of the water filter, in such a manner that the tube connecting member fixed to the inflow tube and the outflow tube is maintained.

The separation prevention cover may have one side contacting a rear portion of the head portion, and the other side fixed to the housing, such that movement of the head portion in a direction away from the housing is limited.

The separation prevention cover may include a cover body including a receiving space receiving the head portion, and a movement protrusion protruding from the cover body to a predetermined height and connected to the housing.

The cover body may further include a fixing portion extending from an inner side thereof toward the inflow tube and the outflow tube, to fix the inflow tube and the outflow tube.

The connection release member may include a half-groove notch portion configured to have one side extending in a direction toward the head portion included in the close contact member, and the other side fixed to the housing, to be in contact with the head portion and thus prevent movement of the close contact member.

The housing may include a movement groove continuously formed in a movement direction of the separation prevention cover or the connection release member.

The separation prevention cover or the connection release member may include a movement protrusion inserted into the movement groove formed to be concave.

The enlarged coupling portion may include a coupling groove into which the coupling body is inserted.

The coupling groove may be provided in a continuously concave form formed to have a predetermined length in a direction toward the second flow tube.

The coupling body may include a coupling protrusion inserted into the coupling groove.

According to an aspect of the present disclosure, a water purifier includes a body part configured to allow for an inflow of water thereinto; a plurality of water filters disposed inside the body part, configured to filter the water flowing thereinto, and each including an inflow tube and an outflow tube; and the flow tube connection module described above, disposed in the body part, and associated with the inflow tube and the outflow tube to connect the plurality of water filters to one another.

The number of housings included in the flow tube connection module may be the same as the number of the plurality of water filters, a pair of tube connecting members may be disposed in a coupling space provided in the housing, the inflow tube and the outflow tube, provided as a first flow tube, may be connected to first flow channel connection ports provided in the tube connecting members, respectively, and a second flow tube may be connected to a second flow channel connection port provided in each of the tube connecting members, to connect different water filters among the plurality of water filters.

### Advantageous Effects

According to an exemplary embodiment in the present disclosure, a flow tube, through which a fluid flows, in detail, an inflow tube and an outflow tube provided in a water filter, may be connected to each other, and as an inflow tube and an outflow tube provided in each of a plurality of water filters are connected, supplied water may be sequentially passed through the water filters, thereby providing purified water with high water quality.

In this case, by providing a connection module having a simplified connection structure, miniaturization of a product and a reduced number of components may be obtained.

Further, connection and separation operations of flow tubes may be efficiently carried out, thereby increasing ease of use.

### DESCRIPTION OF DRAWINGS

FIG. 1 is a perspective view illustrating a state in which a first embodiment of a flow tube connection module in the present disclosure is applied to a water filter.

FIG. 2 is an exploded perspective view of FIG. 1.

FIG. 3 is an exploded perspective view of the first embodiment of the flow tube connection module according to an exemplary embodiment in the present disclosure.

FIG. 4 is a perspective view illustrating that a head portion of a water filter is received in a separation prevention cover of the first embodiment of the flow tube connection module according to an exemplary embodiment in the present disclosure.

FIG. 5 is a cross-sectional perspective view of a tube connecting member of the first embodiment of the flow tube connection module according to an exemplary embodiment in the present disclosure.

FIG. 6 is a cross-sectional perspective view illustrating a state in which a first flow tube is connected to the tube connecting member of the first embodiment of the flow tube connection module according to an exemplary embodiment in the present disclosure.

FIG. 7 is a cross-sectional view of the tube connecting member of the first embodiment of the flow tube connection module according to an exemplary embodiment in the present disclosure.

FIG. 8 is a cross-sectional view illustrating a state in which the first flow tube is connected to the tube connecting member of the first embodiment of the flow tube connection module according to an exemplary embodiment in the present disclosure.

FIG. 9 is a perspective view illustrating a state in which a second embodiment of a flow tube connection module according to an exemplary embodiment in the present disclosure is applied to a water filter.

FIG. 10 is an exploded perspective view of FIG. 9.

FIG. 11 is an exploded perspective view of the second embodiment of the flow tube connection module according to an exemplary embodiment in the present disclosure.

FIG. 12 is a cross-sectional perspective view of a tube connecting member of the second embodiment of the flow tube connection module according to an exemplary embodiment in the present disclosure.

FIG. 13 is a cross-sectional perspective view illustrating a state in which a first flow tube is connected to the tube connecting member of the second embodiment of the flow tube connection module according to an exemplary embodiment in the present disclosure.

FIG. 14 is a cross-sectional view illustrating a state before an operation of the tube connecting member of the second embodiment of the flow tube connection module according to an exemplary embodiment in the present disclosure.

FIG. 15 is a cross-sectional view illustrating a state after an operation of the tube connecting member of the second embodiment of the flow tube connection module according to an exemplary embodiment in the present disclosure.

FIG. 16 is a cross-sectional view taken along line A-A′ of FIG. 10, and illustrating a state in which water flows into the tube connecting member of the second embodiment of the flow tube connection module according to an exemplary embodiment in the present disclosure.

FIG. 17 is a cross-sectional view taken along line A-A′ of FIG. 10, and illustrating a state in which no water flows inside the tube connecting member of the second embodiment of the flow tube connection module according to an exemplary embodiment in the present disclosure.

### MODE FOR INVENTION

In order to facilitate an understanding of the description of exemplary embodiments in the present disclosure, elements denoted by the same reference numerals in the accompanying drawings are the same elements, and among elements performing the same function in respective exemplary embodiments, relevant elements are represented by the same or similar reference numerals.

Further, in order to clarify the gist of the present disclosure, descriptions of elements and techniques known in the related art will be omitted, and exemplary embodiments in the present disclosure will be described in detail with reference to the accompanying drawings.

In addition, the present disclosure is not limited to the exemplary embodiments provided herein, but may be suggested by those skilled in the art in other forms in which specific constituent elements are added, changed or deleted, within the scope of the present invention.

First, according to an exemplary embodiment, a flow tube connection module capable of interconnecting a plurality of flow tubes may be provided. In detail, the flow tube may be an inflow tube and an outflow tube provided in a water filter of a water purifier. However, an exemplary embodiment in the present disclosure is not limited thereto, and various types of flow tubes, through which a fluid flows, may be applied thereto.

Hereinafter, as an exemplary embodiment in the present disclosure, a case applied to an inflow tube and an outflow tube provided in a water filter will be described.

### First Embodiment of Flow Tube Connection Module

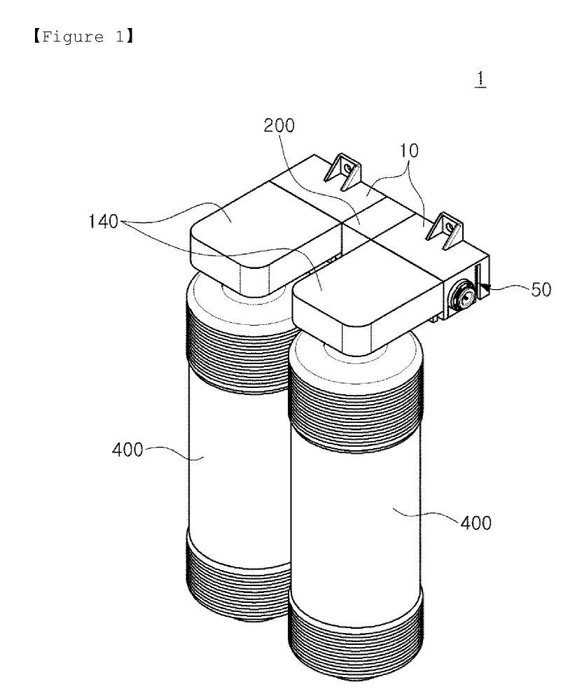

Hereinafter, a first embodiment of a flow tube connection module 1 in the present disclosure will be described with reference to FIGS. 1 to 8.

As illustrated in FIG. 1, the first embodiment of the flow tube connection module 1 in the present disclosure may be modularized by a plurality of housings 10 and a coupling body 200 connecting the housings 10. One side of the coupling body 200 may be coupled to an enlarged coupling portion 50 provided on one side of the housing 10, and the other side of the coupling body 200 may be coupled to the enlarged coupling portion 50. Thus, the number of the housings 10 may be increased without limitation.

FIG. 1 illustrates a state in which a pair of the housings 10 are modularized by a single coupling body 200 according to the first embodiment of the flow tube connection module 1, and a water filter 400 is connected to each of the housings 10. However, it should be understood that an exemplary embodiment in the present disclosure is not limited thereto, but may be appropriately modified and applied according to requirements of those skilled in the art.

In the first embodiment of the flow tube connection module 1, a separation prevention cover 140 may be provided to cover an inflow tube 410 and an outflow tube 420 of the water filter 400 to prevent the water filter 400 from being separated from the housing 10. The inflow tube 410 and the outflow tube 420 of the water filter 400 may be connected according to the first embodiment of the flow tube connection module in the present disclosure, to constitute a first flow tube 20.

As illustrated in FIG. 1, the separation prevention cover 140 may maintain a state covering one side of an upper portion of the water filter 400, in a state in which the water filter 400 is connected thereto.

For example, the separation prevention cover 140 may be configured to prevent the inflow tube 410 and the outflow tube 420 of the water filter 400 from being pushed in a direction away from the housing 10 due to the pressure of water flowing through the inflow tube 410 and the outflow tube 420 of the water filter 400. The separation prevention cover 140, provided in the first embodiment of the flow tube connection module 1 in the present disclosure, may be configured to push one side of an upper portion of the water filter 400 in which the inflow tube 410 and the outflow tube 420 are provided, for example, a head portion HD, in a direction toward the housing 10.

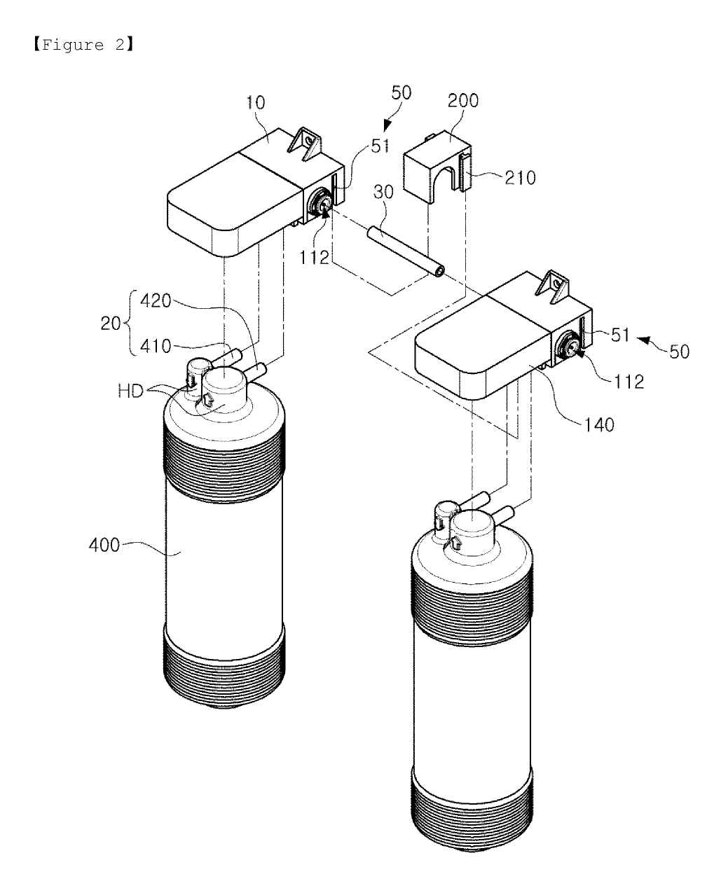

FIG. 2 illustrates an exploded perspective view of FIG. 1. With reference to FIG. 2, a second flow channel connection port 112 of a tube connecting member 110 to be described later may be exposed to a side of the housing 10 in which the enlarged coupling portion 50 of the housing 10 is provided, and may be disposed to oppose a second flow channel connection port 112 of another housing 10 disposed in the vicinity thereof.

In addition, as the second flow channel connection ports 112 are connected to one side and the other side of a second flow tube 30, respectively, a structure in which one pair of water filters 400 are connected to each other may be provided. In detail, the second flow tube 30 may be disposed to be received in an interior of the coupling body 200, to be protected thereby and be prevented from being separated from the second flow channel connection port 112.

The coupling body 200 may include coupling protrusions 210 inserted into coupling grooves 51 provided in the enlarged coupling portion 50, to be coupled to one pair of housings 10. The configuration above is based on the first embodiment of the flow tube connection module 1 in the present disclosure, and thus, in order to combine the housings 10 with the coupling body 200, various exemplary embodiments may be used, as well as the coupling protrusions 210 and the coupling grooves 51.

On the other hand, as illustrated in FIG. 2, one housing 10 may be provided with one separation prevention cover 140 installed thereon, to which one water filter 400 may be connected.

The water filter 400 may include an inflow tube 410 and an outflow tube 420 disposed on an upper portion thereof, and this upper portion may be referred to as a head portion HD of the water filter 400. A filtration member (not shown) may be provided in an inside of the water filter 400, and water introduced through the inflow tube 410 may be passed through the filtration member and then be discharged through the outflow tube 420 by internal pressure. The flow of water inside the water filter 400 is commonly known in the art, and thus, a detailed description thereof will be omitted.

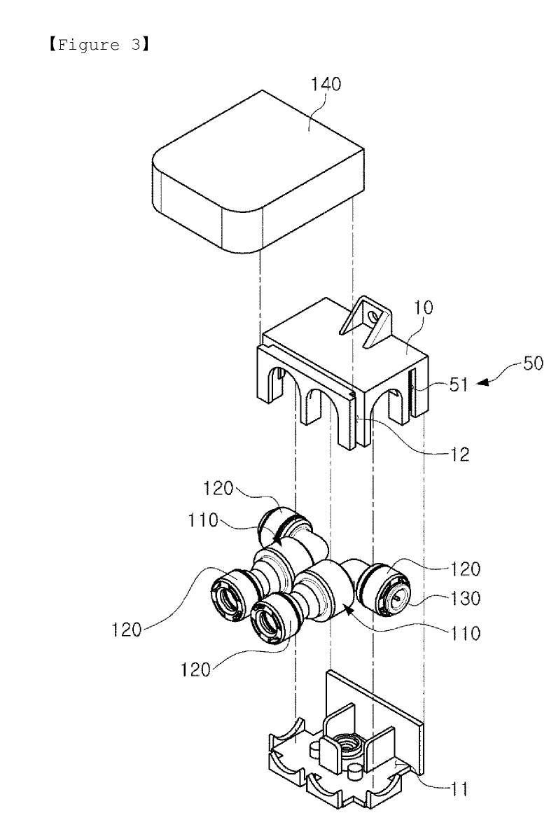

A coupling space 11 may be provided in the housing 10 as illustrated in FIG. 3. The coupling space 11 may be a space for coupling of the inflow tube 410 and the outflow tube 420 of the water filter 400. For example, the tube connecting member 110 coupled to the inflow tube 410 and the outflow tube 420 of the water filter 400 may be disposed in the coupling space. The tube connecting member 110 may be provided as a pair in the coupling space 11. One tube connecting member 110 may be connected to the inflow tube 410, and the other tube connecting member 110 may be connected to the outflow tube 420.

In addition, the housing 10 may be provided with a movement groove 12 formed in a side surface thereof. The movement groove may be provided in such a manner that the separation prevention cover 140 may be coupled thereto to move therein.

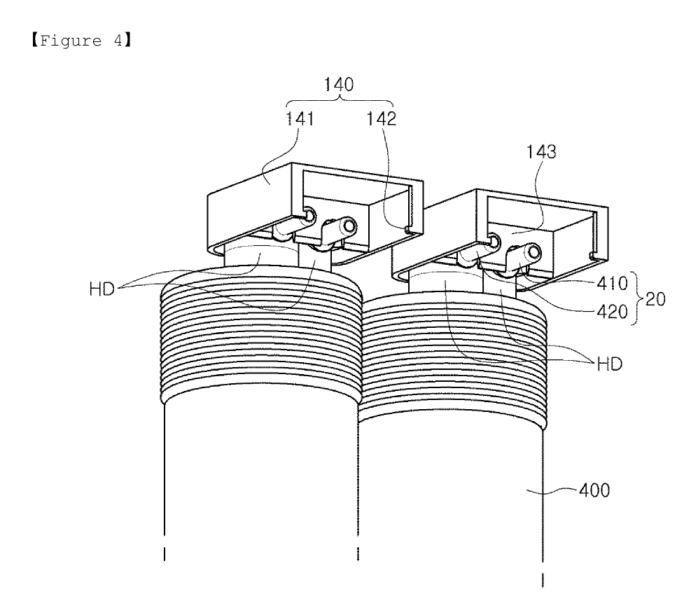

On the other hand, as illustrated in FIG. 4, the separation prevention cover 140 may include a cover body 141 receiving the head portion HD of the water filter 400, and a movement protrusion 142 disposed on the cover body 141 and inserted into the movement groove 12 of the housing 10. In detail, the separation prevention cover 140 may further include a fixation member 143 fixing the inflow tube 410 and the outflow tube 420 of the water filter 400.

The cover body 141 may receive the head portion HD of the water filter 400, and may be provided to cover a rear portion of the head portion HD to prevent the head portion HD from being pushed in a direction away from the housing 10. Since the movement protrusion 142 is inserted into the movement groove 12 of the housing 10, a user may lift or lower the separation preventing cover 140. By the fixation member 143 fixing the inflow tube 410 and the outflow tube 420 of the water filter 400 from an outer side thereof, movement of the inflow tube 410 and the outflow tube 420 in a diameter direction may be limited, and thus, a connection state of the water filter 400 may be more firmly maintained.

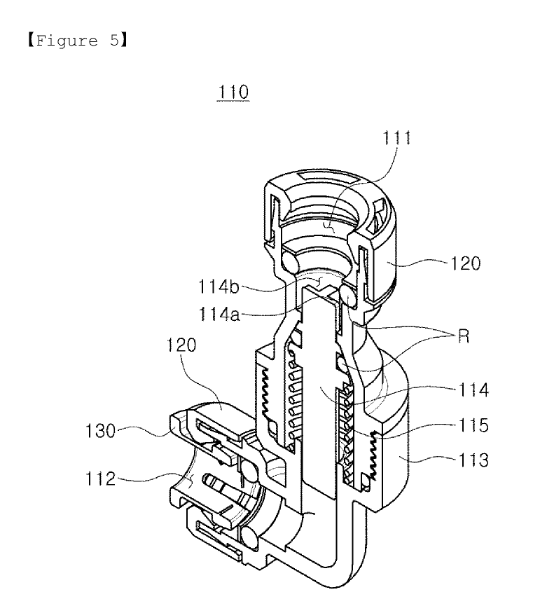

FIGS. 5 to 8 illustrate the tube connecting member 110 connected to the inflow tube 410 and the outflow tube 420 of the water filter 400 and allowing for a flow of water.

A connection member housing 113, constituting an appearance of the tube connecting member 110, may have a predetermined space therein through which a fluid may flow, and an opening and closing member 114 and an elastic member 115 may be installed in the predetermined space.

The opening and closing member 114 may include a rib portion 114a having a cruciform (+) shape and provided adjacently to first flow channel connection ports 111 to which the inflow tube 410 and the outflow tube 420 of the water filter 400 are connected. In addition, an O-ring R for sealing may be provided on upper and lower portions of the opening and closing member 114, respectively, thereby preventing water leakage.

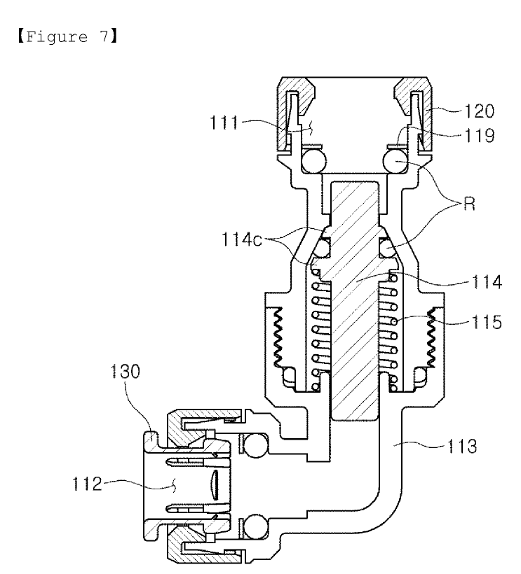

Further, an additional O-ring R may be provided on a side surface of the opening and closing member 114, to prevent the opening and closing member 114 from coming into close contact with an inner surface of the connection member housing 113 and water leakage therebetween. As illustrated in FIG. 7, in order to fix the O-ring R, a plurality of ring fixing portions 114c, protruding and spaced apart from each other with a predetermined interval therebetween, may be provided on the side surface of the opening and closing member 114. By the ring fixing portions 114c described above, the opening and closing member 114 itself may be provided with the O-ring R without additional components, thereby obtaining an effect of reduction in the number of components.

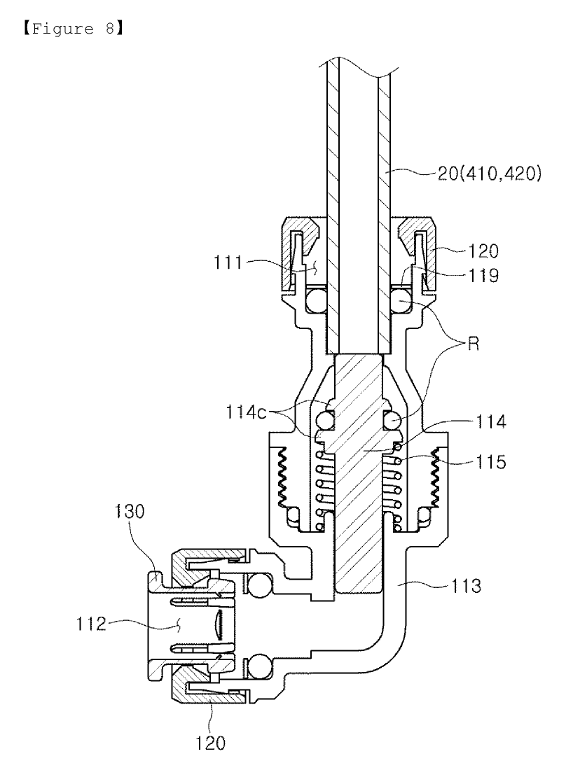

An elastic member 115 may be disposed below the ring fixing portions 114c. As illustrated in FIG. 8, for example, when the inflow tube 410 is inserted, the opening and closing member 114 may be lowered, and thus, the elastic member 115 may be contracted. As described above, when the inflow tube 410 and the opening and closing member 114 are in contact with each other, a path through which water may flow is formed inside the connection member housing 113 of the tube connecting member 110.

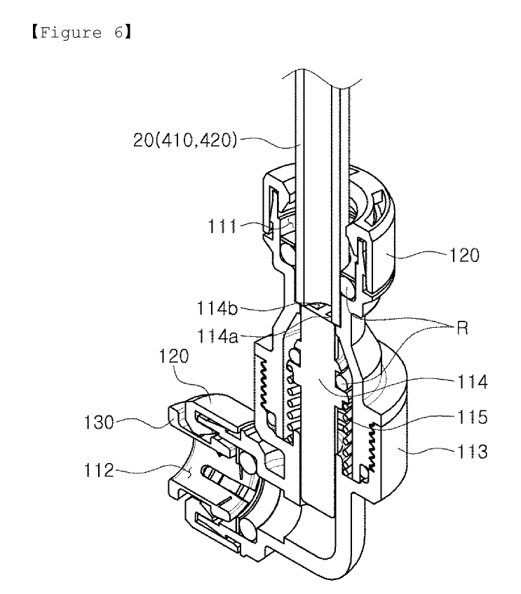

For example, as illustrated in FIGS. 5 and 6, before the inflow tube 410 is inserted, the opening and closing member 114 may be in a raised state and the elastic member 115 may also be in an extended state, inside the connection member housing 113. At this time, the rib portion 114a of the opening and closing member 114 is in a state in which it is disposed closely to a connection cap 120, and in this state, since the opening and closing member 114 closes a flow path inside the connection member housing 113, water may not flow.

Subsequently, as illustrated in FIG. 6, the inflow tube 410 may be inserted into the connection member housing 113, to lower the opening and closing member 114. Then, while the rib portion 114a of the opening and closing member 114 is lowered, a flow space 114b may be formed in the connection member housing 113. Then, water having passed through the inflow tube 410 enters the flow space 114b, passes through the connection member housing 113, and moves to the second flow channel connection port 112.

Subsequently, for example, when the inflow tube 410 moves in a direction away from the opening and closing member 114 to be released from contact with the opening and closing member 114, as the elastic member 115 may be extended, the opening and closing member 114 moves toward the first flow channel connection port 111 again. In this case, the flow space 114b inside the connection member housing 113 may be closed again and water may not flow.

Thus, a user may insert the inflow tube 410 into the first flow channel connection port 111, and may insert the second flow tube 30 into the second flow channel connection port 112 as illustrated in FIG. 2. Thus, water flowing through the inflow tube 410 of the water filter 400 may be supplied to the second flow tube 30. Then, the water may be transferred to an inflow tube 410 of another water filter 400 by the second flow tube 30.

In this case, the description of the inflow tube 410 above may also be applied to the outflow tube 420 coupled to the tube connecting member 110 provided as a pair in a single house 10 in the same manner.

On the other hand, for example, in the case in which the inflow tube 410 or the outflow tube 420 is inserted into the connection cap 120 as illustrated in FIG. 8, the inflow tube 410 or the outflow tube 420 may be moved in a direction away from the opening and closing member 114 due to the pressure of water. For example, since a leakage phenomenon may occur in the case in which the inflow tube 410 is pushed in a direction away from the opening and closing member 114, it may be required to prevent the inflow tube 410 from being pushed in the direction away from the opening and closing member 114.

Thus, the separation prevention cover 140 described above according to an exemplary embodiment in the present disclosure may be provided. For example, when the water filter 400 is connected, the separation prevention cover 140 may be lowered in a direction toward the head portion HD of the water filter 400 as illustrated in FIG. 1. Then, the separation prevention cover 140 may come into a state illustrated in FIG. 4 while contacting the head portion HD.

In detail, the inflow tube 410 and the outflow tube 420 of the water filter 400 may be fixed by the fixation member 143 of the separation prevention cover 140, and one side of the cover body 141 of the separation prevention cover 140 may be disposed on a rear portion of the head portion HD of the water filter 400. Then, the cover body 141 may serve to support the rear portion of the head portion HD, such that the head portion HD of the water filter 400 may be prevented from being pushed.

Thus, as illustrated in FIG. 8, even when the inflow tube 410 and the outflow tube 420 are connected to the tube connecting members 110, respectively, to be in a contact state with the opening and closing member 114, the inflow tube 410 and the outflow tube 420 may be prevented from being pushed in a direction away from the opening and closing member 114, and a connection state of the water filter 400 may be maintained without water leakage.

On the other hand, in detail, a close contact member 130 illustrated in FIG. 8 may be provided in the second flow channel connection port 112. The second flow channel connection port 112 may be connected to the second flow tube 30, and for example, when the close contact member 130 is installed in the second flow channel connection port 112, the close contact member 130 may compress the second flow tube 30 in a central direction, to fix the second flow tube 30. Thus, the second flow tube 30 may be prevented from being separated from the second flow channel connection port 112, but an exemplary embodiment thereof is not limited thereto, and may be appropriately modified and applied.

On the other hand, a non-described element above is a washer 119 in FIGS. 7 and 8, which may be provided on one side of the O-ring R.

### Second Embodiment of Flow Tube Connection Module

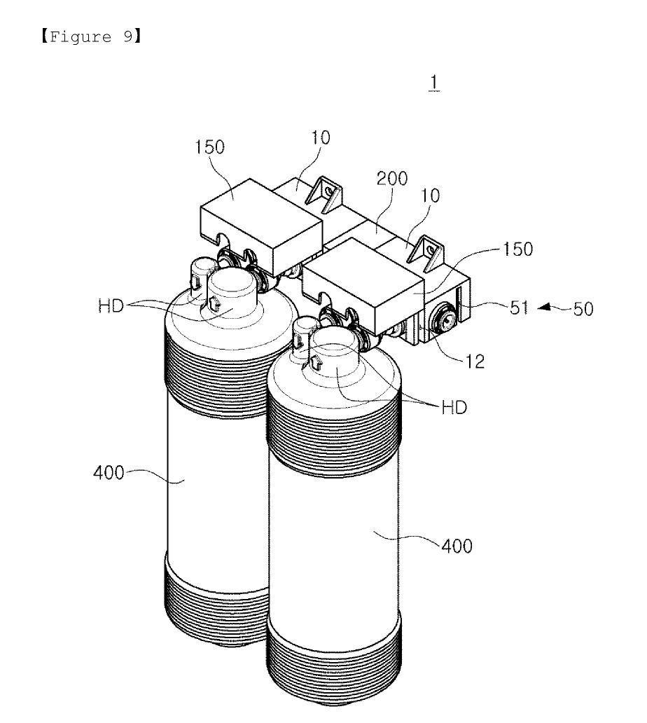

Hereinafter, a second embodiment of the flow tube connection module 1 in the present disclosure will be described with reference to FIGS. 9 to 17.

As illustrated in FIG. 9, according to the second embodiment of the flow tube connection module 1 in the present disclosure, the flow tube connection module 1 may include a housing 10 to which a water filter 400 is connected, and a coupling body 200 connecting the housings 10 to each other. In this case, the housing 10 may include components required for connection and fixing of the water filter 400.

FIG. 9 illustrates a state in which water filters 400 are connected to each other by the flow tube connection module 1, while a plurality of water filters 400 are coupled to the flow tube connection module 1. Thus, water supplied in this state may sequentially pass through the respective water filters 400, and in this process, water may be filtered or purified.

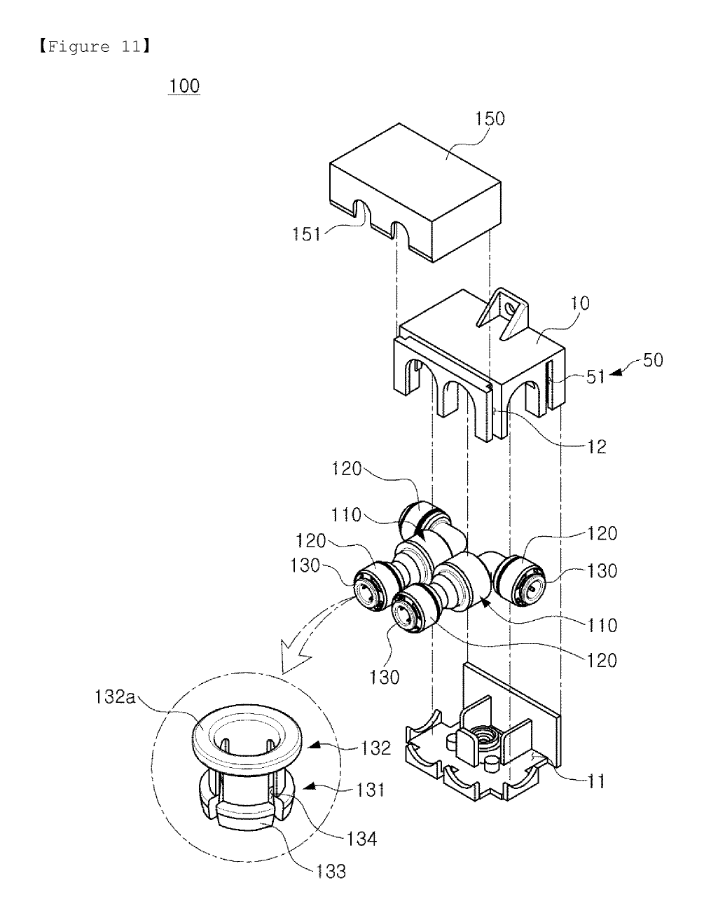

As illustrated in FIG. 11, a coupling space 11 for flow tubes 20 and 30 may be provided in the housing 10, and may include additional components, such as a screw, a bracket, and the like, required for fixing and connecting the flow tubes 20 and 30.

A first flow tube 20 and a second flow tube 30 may be connected to each other in the coupling space 11 of the housing 10, by a tube connecting member 110 disposed in the coupling space 11.

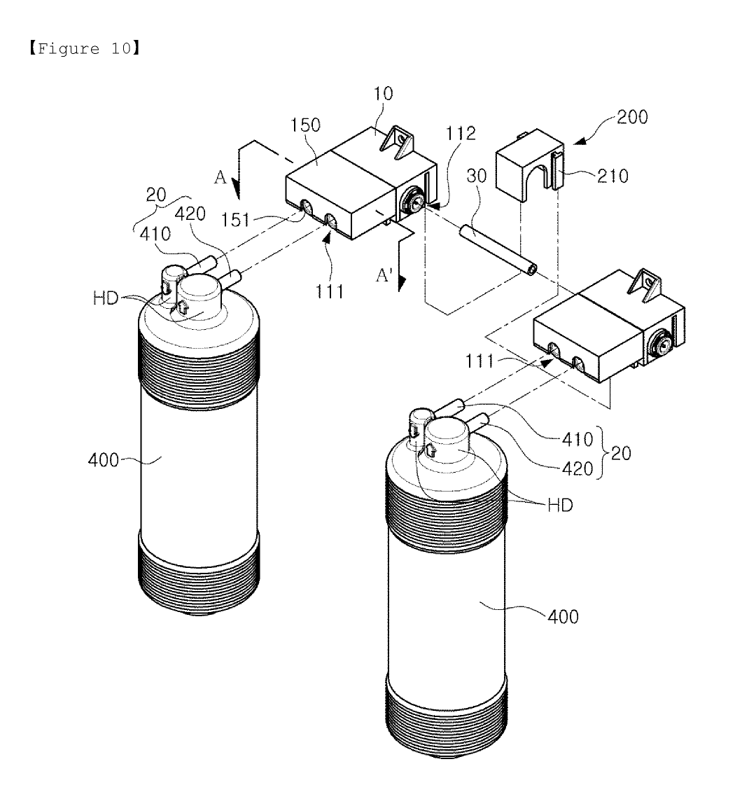

As illustrated in FIGS. 10 and 11, the tube connecting member 110 may include a first flow channel connection ports 111 to which a first flow tube 20 is connected, and a second flow channel connection port 112 to which a second flow tube 30 is connected. In this case, the first flow tube 20 may be, in detail, an inflow tube 410 and an outflow tube 420 of the water filter 400, and the second flow tube 30 may be provided to connect the water filters 400.

In order to fix the water filter 400 including the inflow tube 410 and the outflow tube 420, one pair of tube connecting members 110 may be provided in the housing 10 as illustrated in FIG. 11. In addition, as illustrated in FIG. 10, the inflow tube 410 and the outflow tube 420 of the water filter 400 may be inserted into the first flow channel connection ports 111 of the tube connecting member 110, respectively.

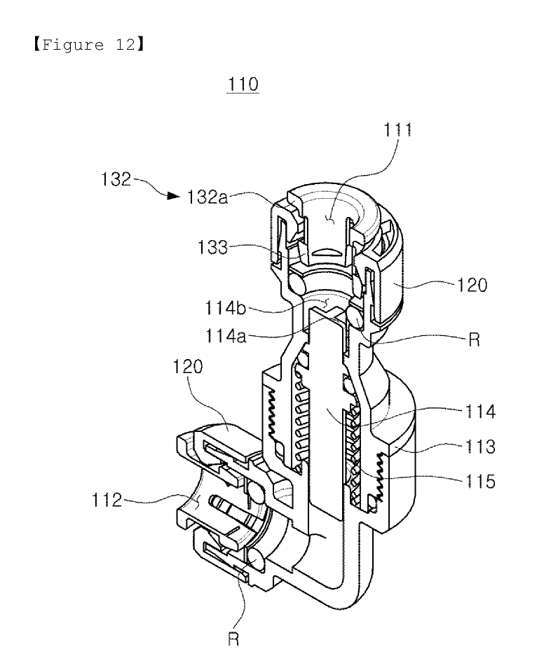

The tube connecting member 110 may be configured as illustrated in FIGS. 12 to 15, to allow a fluid to flow in the inside thereof, while fixing the inflow tube 410 and the outflow tube 420.

A connection member housing 113, constituting an appearance of the tube connecting member 110, may have a predetermined space therein through which a fluid may flow, and an opening and closing member 114 and an elastic member 115 may be installed in the predetermined space.

The opening and closing member 114 may include a rib portion 114a having a cruciform(+) shape and being relatively adjacent to the first flow channel connection port 111. In addition, an O-ring R for sealing may be provided on upper and lower portions of the opening and closing member 114, respectively, thereby preventing water leakage.

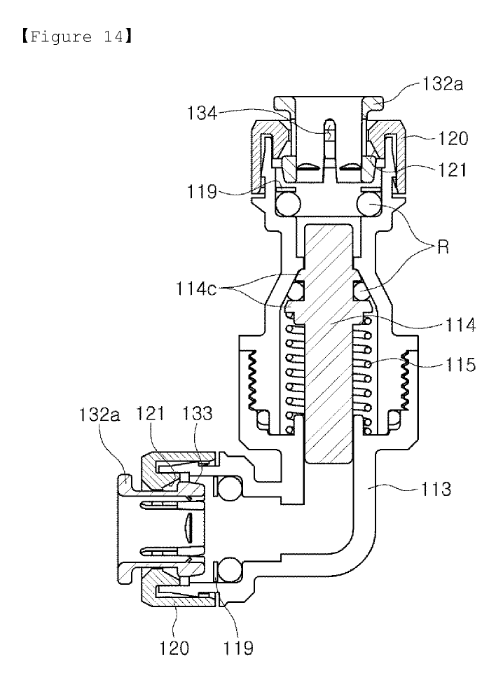

Further, as illustrated in FIG. 14, an additional O-ring R may be provided on a side surface of the opening and closing member 114, to prevent the opening and closing member 114 from coming into close contact with an inner surface of the connection member housing 113 and water leakage therebetween. In addition, in order to fix the O-ring R, a plurality of ring fixing portions 114c, protruding and spaced apart from each other with a predetermined interval therebetween, may be provided on the side surface of the opening and closing member 114.

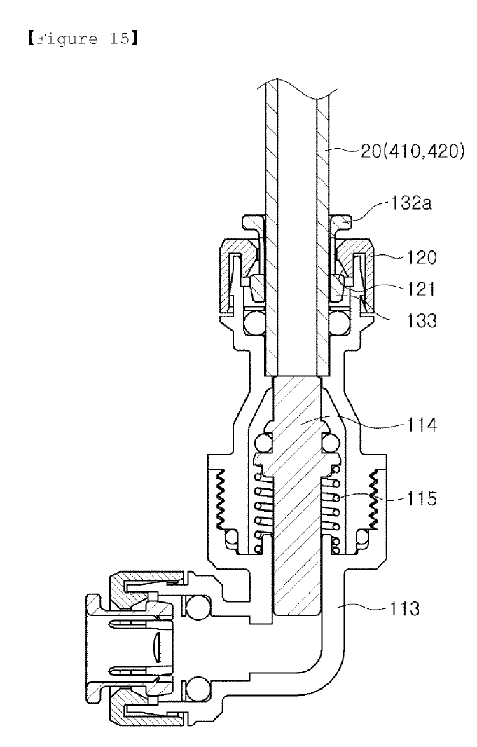

The elastic member 115 may be disposed below the ring fixing portions 114c. As illustrated in FIG. 15, for example, when the first inflow tube 20 is inserted, the opening and closing member 114 may be lowered, and thus, the elastic member 115 may be contracted. As described above, when the inflow tube 20 and the opening and closing member 114 are in contact with each other, a path through which water may flow may be formed inside the connection member housing 113 of the tube connecting member 110.

For example, as illustrated in FIG. 12, before the first inflow tube 20 is inserted, the opening and closing member 114 may be in a raised state and the elastic member 115 may also be in an extended state, inside the connection member housing 113. At this time, the rib portion 114a of the opening and closing member 114 is in a state in which it is disposed closely to a connection cap 120, and in this state, since the opening and closing member 114 closes a flow path inside the connection member housing 113, water may not flow.

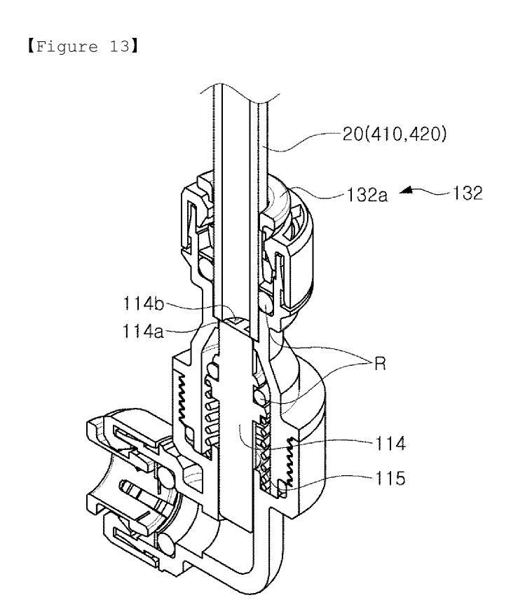

Subsequently, as illustrated in FIG. 13, the first inflow tube 20 may be inserted into the connection member housing, to lower the opening and closing member 114. Then, while the rib portion 114a of the opening and closing member 114 is lowered, a flow space 114b may be formed inside the connection member housing 113. Thus, water having passed through the first inflow tube 20 enters the flow space 114b, passes through the connection member housing 113, and moves to the second flow channel connection port 112.

For example, when the first inflow tube 20 moves in a direction away from the opening and closing member 114 to release from contact with the opening and closing member 114, as the elastic member 115 may be extended, the opening and closing member 114 may remove in a direction toward the first flow channel connection port 111. At this time, the flow space 114b inside the connection member housing 113 may be reclosed and water may not flow.

Thus, as a user inserts the first inflow tube 20 into the first flow channel connection port 111, and inserts the second flow tube 30 into the second flow channel connection port 112, a fluid flowing through the first inflow tube 20 may be supplied to the second flow tube 30.

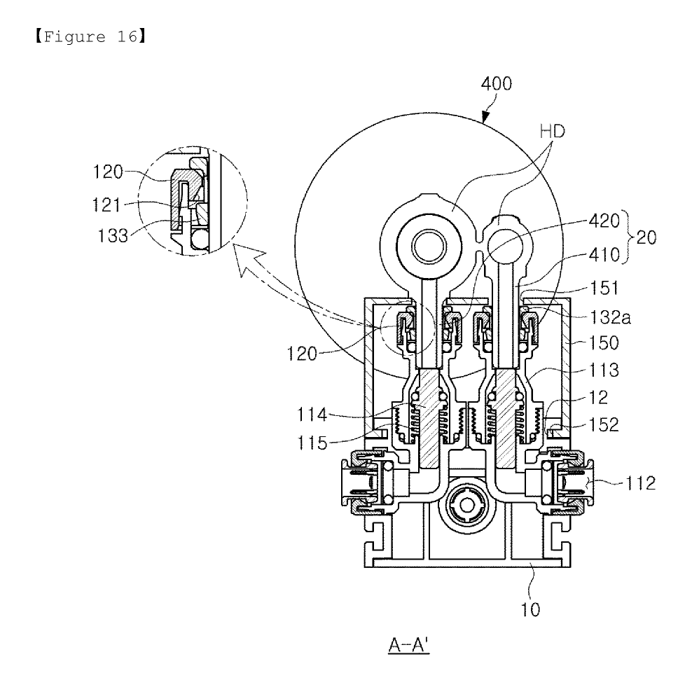

For example, as illustrated in FIG. 16, a pair of tube connecting members 110 may be provided in a coupling space of the housing 10, and one water filter 400 may be connected to one housing 10. Then, the inflow tube 410 and the outflow tube 420 provided in a single water filter 400, for example, the first flow tube 20 may be inserted into the first flow channel connection port 111.

In addition, when the inflow tube 410 and the outflow tube 420 come into contact with the opening and closing member 114 to lower the opening and closing member 114, water may flow through the flow space 114b described above.

In this case, one end of the second flow tube 30 may be inserted into the second flow channel connection port 112 illustrated in FIG. 16, and the other end of the second flow tube 30 may be inserted into a second flow channel connection port 112 of a tube connecting member 110 provided in a housing 10 disposed in the vicinity thereof, thereby allowing the plurality of water filters 400 to be connected to each other.

On the other hand, in order to prevent the inflow tube 410 and the outflow tube 420 from being easily separated from the inside of the tube connecting member 110 when the inflow tube 410 and the outflow tube 420 are inserted into the tube connecting member 110, the connection cap 120 illustrated in FIG. 12 and the close contact member 130 illustrated in FIG. 11 may be inserted into the first and second flow channel connection ports 111 and 112.

As illustrated in FIG. 14, the connection cap 120 may have an inclined portion 121 therein, inclined in a direction toward the first flow tube 20 and the second flow tube 30.

In addition, the close contact member 130 may include a head portion 132 and a body portion 131, as illustrated in an enlarged view of FIG. 11. The body portion 131 may include a separation prevention protrusion 133 protruding toward the inclined portion 121 to move along the inclined portion 121 of the connection cap 120, and a plurality of separation grooves 134 formed in a circumferential direction.

When the close contact member 130 inserted into the connection cap 120 is pressed in a center direction by the connection cap 120, the close contact member 130 may be elastically deformed in the center direction, via the separation grooves 134.

On the other hand, as illustrated in FIG. 13, the head portion 132 may include a stop protrusion 132a disposed outside a connection tab 120. As the head portion 132 is latched to an outer circumference of the connection cap 120 via the stop protrusion 132a, the head portion 132 may be prevented from being pushed into the connection cap 120.

For example, when the first flow tube 20 is inserted as illustrated in FIG. 13 while the close contact member 130 is pressed in an inward central direction, the close contact member 130 may press an outer circumference of the first flow tube 20, and thus, may move along the first flow tube 20.

For example, as illustrated in FIG. 16, when the first flow tube 20 is inserted, a separation prevention protrusion 133 of the close contact member 130 may be released from contact with an inclined portion 121 of the connection cap 120. However, when a user pulls the first flow tube 20 in a direction away from the opening and closing member 114 to separate the water filter 400 therefrom, the close contact member 130 may move along the first flow tube 20, in such a manner that the separation prevention protrusion 133 is caught by the inclined portion 121 of the connection cap. In this case, the inclined portion 121 of the connection cap 120 should be provided such that the separation prevention protrusion 133 may not be released. Thus, a diameter of the connection cap 120 should be less than a circumference of an outer circumference of the separation prevention protrusion 133 of the close contact member 130.

According to the inclined portion 121 and the separation prevention protrusion 133 configured as described above, as the first flow tube 20 is moved in a direction away from the opening and closing member 114 in order to be separated, the separation prevention protrusion 133 of the close contact member 130, and the inclined portion 121 of the connection cap 120 may be further forcibly fitted to each other, such that the first flow tube 20 may not be further separated from the first flow channel connection port 111.

As the first flow tube 20 further moves in a direction away from the opening and closing member 114, the separation prevention protrusion 133 pressed by the inclined portion 121 may further press an outer circumference of the first flow tube 20.

In consideration of the description above, a user may insert the inflow tube 410 and the outflow tube 420 of the water filter 400 into the tube connecting member 110 in a relatively simple manner, while it may be difficult to separate the inflow tube 410 and the outflow tube 420 from the tube connecting member 110.

Thus, in the case of this embodiment, as the close contact member 130 may be prevented from moving in a direction away from the opening and closing member 114, the inclined portion 121 of the connection cap 120 and the separation prevention protrusion 133 of the close contact member 130 may be prevented from being forcibly fitted to each other.

Thus, a connection release member 150 may be provided. By the connection release member 150, the inflow tube 410 and the outflow tube 420, as the first flow tube 20, may be easily separated from the tube connecting member 110.

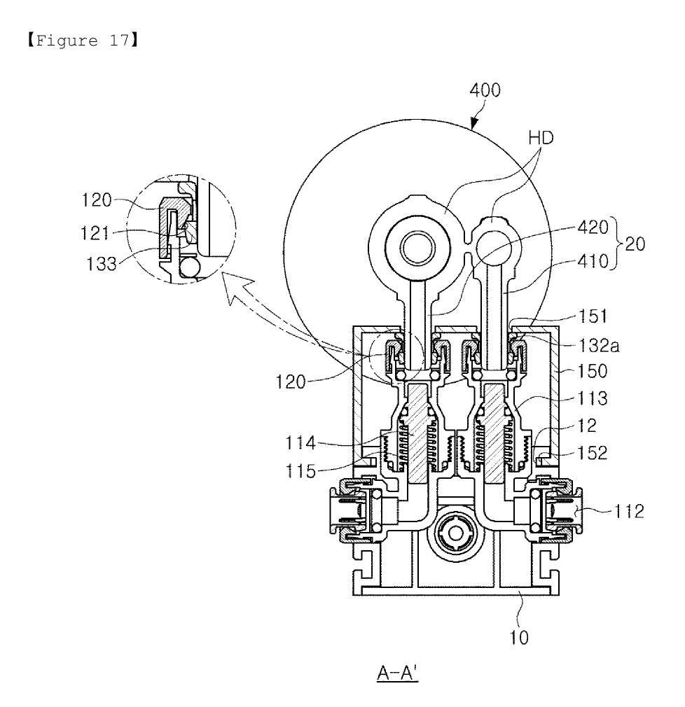

The connection release member 150 may include a movement protrusion 152 protruding toward the first flow tube 20, as illustrated in FIGS. 16 and 17. Further, the housing 10 may include a movement groove 12 into which the movement protrusion 152 is inserted, as illustrated in FIG. 11. Thus, the connection release member 150 may move in a direction toward the tube connecting member 110 in the housing 10.

Further, the connection release member 150 may include a half-groove notch portion 151 extending in a direction toward the head portion 132 of the close contact member 130.

For example, when the connection of the first flow tube 20 is released from the housing 10, the half-groove notch portion 151 may come into contact with the head portion 132 to push the close contact member 130 toward the opening and closing member 114, such that the close contact member 130 may no longer move in a direction away from the opening and closing member 114.

For example, as illustrated in FIGS. 9 and 16, in a state in which the first flow tube 20 is initially inserted, the connection release member 150 may be in a raised state with respect to the first flow tube 20, and the half-groove notch portion 151 may be in a state in which the contact thereof has been released from the stop protrusion 132a of the head portion 132 of the close contact member 130.

Subsequently, when a user lowers the connection release member 150 to separate the water filter 400 as illustrated in FIG. 10, the half-groove notch portion 151 may contact the stop protrusion 132a of the head portion 132 of the close contact member 130. For example, the stop protrusion 132a of the close contact member 130 may no longer move along the first flow tube 20 by the half-groove notch portion 151 in the state illustrated in FIG. 17, and the first flow tube 20 may be easily separated from the close contact member 130.

Thus, when the user separates the inflow tube 410 and the outflow tube 420 from the tube connecting member 110 of the water filter 400, as the user may lower only the connection release member 150 in a direction toward the tube connecting member 110 without any other tool, the inflow tube 410 and the outflow tube 420 may be easily separated.

In addition, as illustrated in FIG. 11, the housing 10 may include an enlarged coupling portion 50 provided as a coupling groove 51, and as illustrated in FIG. 10, a plurality of housings 10 may be connected to each other by the coupling body 200 including a coupling protrusion 210 corresponding to the coupling groove 51.

For example, when the second flow tube 30 is respectively connected to the second flow channel connection ports 112 of the tube connecting members 110, and the coupling body 200 is inserted into the enlarged coupling portions 50 of the plurality of housings 10, the plurality of the housings 10 may be connected to each other, and the inflow tube 410 and the outflow tube 420 of the plurality of water filters 400 may be connected to each other. Thus, the water filters 400 may be modularized.

Water Purifier

Hereinafter, a water purifier according to an exemplary embodiment in the present disclosure will be described.

The water purifier according to an exemplary embodiment may include a body part (not shown), a plurality of water filters 400, and the flow tube connection module 1 described above.

The body part may be provided in such a manner that water may flow thereinto.

The plurality of water filters 400 may be provided inside the body part to filter incoming water. To this end, each of the plurality of water filters 400 may include an inflow tube 410 and an outflow tube 420.

The flow tube connection module 1 may be provided in the body part. Further, the flow tube connection module 1 may be associated with the inflow tube 410 and the outflow tube 420 of the water filter 400 to connect a plurality of water filters 400 to each other.

For example, the number of the housings 10 of the flow tube connection module 1 described above may be the same as the number of the water filters 400. A pair of tube connecting members 110 may be installed in a coupling space 11 provided in the housing 10.

In addition, the inflow tube 410 and the outflow tube 420 of the water filter 400, provided as the first flow tube 20, may be connected to first channel connection ports 111 provided in the respective tube connecting member 110. In addition, a second flow tube 30 may be connected to second flow channel connection ports 112 provided in the respective tube connecting member 110, in such a manner that different water filters 400 are connected to each other.

While exemplary embodiments have been shown and described above, it will be apparent to those skilled in the art that modifications and variations could be made without departing from the scope of the present invention as defined by the appended claims.

1. A flow tube connection module comprising:
a housing having a coupling space in which a first flow tube and a second flow tube are connected to each other;
a tube connecting member provided in the coupling space and connecting the first flow tube and the second flow tube to each other;
an enlarged coupling portion provided in the housing;
a coupling body coupled to the enlarged coupling portion to connect a plurality of the housings; and
a separation prevention cover or a connection release member assisting the first flow tube in being connected to or separated from the tube connecting member.

2. The flow tube connection module of claim 1, wherein the first flow tube is provided as an inflow tube and an outflow tube provided in a head portion of a water filter.

3. The flow tube connection module of claim 2, wherein the tube connecting member comprises a first flow channel connection port to which the first flow tube is connected, and a second flow channel connection port to which the second flow tube is connected.

4. The flow tube connection module of claim 3, wherein the tube connecting member comprises connection caps installed in the first flow channel connection port and the second flow channel connection port, to fix the first flow tube and the second flow tube, respectively.

5. The flow tube connection module of claim 4, further comprising a close contact member inserted into at least one of the connection caps to be in close contact with the first flow tube or the second flow tube.

6. The flow tube connection module of claim 5, wherein the connection cap comprises an inclined portion configured to be inclined in a length direction of the first flow tube or the second flow tube, and
the close contact member is moved along the inclined portion when the first flow tube or the second flow tube moves, to be in close contact with the first flow tube or the second flow tube.

7. The flow tube connection module of claim 6, wherein the close contact member comprises:
a body portion inserted into the connection cap to be in close contact with the first flow tube or the second flow tube, and to be in contact with the inclined portion, and
a head portion extended from the body portion outwardly of the connection cap, to be exposed externally of the connection cap.

8. The flow tube connection module of claim 7, wherein the body portion comprises a separation prevention projection protruding toward the inclined portion to move along the inclined portion, and a plurality of separation grooves formed in a circumferential direction thereof, and is configured to be elastically transformed in a center direction when the connection cap presses the body portion in the center direction.

9. The flow tube connection module of claim 8, wherein the head portion comprises a stop protrusion protruding outwardly of the connection cap.

10. The flow tube connection module of claim 4, wherein the separation prevention cover is provided on the housing to move, and is configured to extend in an outer circumferential direction of the water filter, in such a manner that the tube connecting member fixed to the inflow tube and the outflow tube is maintained.

11. The flow tube connection module of claim 10, wherein the separation prevention cover has one side contacting a rear portion of the head portion, and the other side fixed to the housing, such that movement of the head portion in a direction away from the housing is limited.

12. The flow tube connection module of claim 11, wherein the separation prevention cover comprises a cover body including a receiving space receiving the head portion, and a movement protrusion protruding from the cover body to a predetermined height and connected to the housing.

13. The flow tube connection module of claim 12, wherein the cover body further comprises a fixing portion extending from an inner side thereof toward the inflow tube and the outflow tube, to fix the inflow tube and the outflow tube.

14. The flow tube connection module of claim 5, wherein the connection release member comprises a half-groove notch portion configured to have one side extending in a direction toward the head portion included in the close contact member, and the other side fixed to the housing, to be in contact with the head portion and thus prevent movement of the close contact member.

15. The flow tube connection module of claim 1, wherein the housing comprises a movement groove continuously formed in a movement direction of the separation prevention cover or the connection release member.

16. The flow tube connection module of claim 15, wherein the separation prevention cover or the connection release member comprises a movement protrusion inserted into the movement groove formed to be concave.

17. The flow tube connection module of claim 1, wherein the enlarged coupling portion comprises a coupling groove into which the coupling body is inserted.

18. The flow tube connection module of claim 17, wherein the coupling groove is provided in a continuously concave form formed to have a predetermined length in a direction toward the second flow tube.

19. The flow tube connection module of claim 17, wherein the coupling body comprises a coupling protrusion inserted into the coupling groove.

20. A water purifier comprising:
a body part configured to allow for an inflow of water thereinto;
a plurality of water filters disposed inside the body part, configured to filter the water flowing thereinto, and each including an inflow tube and an outflow tube; and
the flow tube connection module of claim 1, disposed in the body part, and associated with the inflow tube and the outflow tube to connect the plurality of water filters to one another.

21. (canceled)
